(19) United States
(12) Patent Application Publication
(10) Pub. No.: US 2026/0268077 A1
(43) Pub. Date: Sep. 10, 2026

(54) MULTIMODAL GENERATIVE INFORMATION RETRIEVAL SYSTEM WITH PRECISE ANSWER LOCALIZATION AND CONTENT-AWARE RENDERING

(71) Applicant: Base64.ai, Inc., New York, NY (US)

(72) Inventors: Ozan Eren Bilgen, New York, NY (US); Christopher Wade Huff, Weston, FL (US); Alperen Sahin, Istanbul (TR); Fatih Kiyikci, Ankara (TR); Onur Cunedioglu, Istanbul (TR); Bahadir Kisbet, Ankara (TR); Mert Donmezyurek, Istanbul (TR); Batuhan Ceylan, Balikesir (TR); Christopher Maertz, Fox Point, WI (US)

(21) Appl. No.: 19/075,601

(22) Filed: Mar. 10, 2025

(51) Int. Cl. G06F 40/20; G06F 16/334; G06F 16/338

(52) U.S. Cl. CPC G06F 40/20; G06F 16/3347; G06F 16/338

(57) ABSTRACT

Systems and methods of processing and displaying answers derived from various types of documents based on user queries. Systems and methods involve comparing embeddings of a query, a target document, and one or more reference document to develop answers by evaluating the query. Systems and methods includes storing the embeddings of the target document, reference document, and user query in a vector database. Cosine similarities can be calculated to identify relevant reference documents. Furthermore, the answer generated incorporates at least one location featuring a visual indicator in the relevant reference document, enhancing a user's ability to identify pertinent information visually.

### FIELD OF THE INVENTION

The field of the invention is vector searching and generative artificial intelligence.

### BACKGROUND

The background description includes information that may be useful in understanding the present invention. It is not an admission that any of the information provided in this application is prior art or relevant to the presently claimed invention, or that any publication specifically or implicitly referenced is prior art.

Retrieval augmented generation (RAG) represents a significant advancement over traditional methods in the fields of information retrieval and artificial intelligence. Unlike conventional approaches that rely solely on predefined databases or purely generative models, RAG combines the strengths of both retrieval and generation components. This hybrid method allows for the extraction of pertinent information from reference documents, which is then used to generate relevant and contextually accurate responses.

One of the primary advantages of RAG is its ability to dynamically access and integrate up-to-date data, ensuring the responses are not only accurate but also timely. Traditional retrieval methods often suffer from limitations related to static databases, resulting in outdated or irrelevant information being presented. Conversely, purely generative models, while excellent in producing fluent and coherent text, may lack the factual accuracy and specificity provided by retrieval-based methods.

Another notable superiority of RAG is its adaptability and scalability. The retrieval mechanism can efficiently handle vast amounts of data, making it suitable for applications requiring extensive knowledge bases. The generative component, on the other hand, excels in creating natural language text, which enhances the user experience by providing articulate and contextually appropriate outputs. This dual capability ensures that RAG can cater to a wide range of applications, from customer service automation to complex data analysis tasks.

Retrieval augmented generation represents an area of generative AI technologies that is vastly applicable and ripe for innovation, and given its advantages and uses, there is a need for improved systems and methods that implement RAG more efficiently and more effectively than anything that currently exists.

### SUMMARY OF THE INVENTION

The present inventive subject matter provides systems and methods directed to using LLMs and other AI models to answer questions about one document in view of the content in one or more reference documents.

In one aspect of the inventive subject matter, a method of using artificial intelligence to generate responses to queries about target documents in view of reference documents comprises the steps of: receiving a set of reference documents; processing the set of reference documents to create reference document embeddings for each reference document in the set; receiving a target document and a query, wherein the query is related to the target document; processing the target document to create target document embeddings; processing the query to create query embeddings; identifying at least one relevant reference document by comparing the query embeddings to the reference document embeddings; using the target document embeddings, embeddings of the at least one relevant reference document, and the query embeddings to generate an answer, wherein the answer evaluates the query using the target document and the at least one relevant reference document; transmitting the answer to a user device; and displaying the answer via user interface on the user device.

In some embodiments, the target document or any of the reference documents can feature one or any combination of a text-based file, a video-based file, an image-based file, and an audio-based file. In some embodiments, the method also includes the steps of storing the target document embeddings to a vector database, storing the reference document embeddings to the vector database, and storing the query embeddings to the vector database. A generated answer can also include at least one location and location indicator that points to the at least one location in the relevant reference document.

In some embodiments, the step of comparing the query embeddings and the reference document embeddings involves calculating cosine similarities between the query embeddings and the reference document embeddings.

In another aspect, a method of using artificial intelligence to generate responses to queries about target documents in view of reference documents comprises the steps of: receiving a reference document; processing the reference documents to create reference document embeddings; storing the reference document embeddings to a vector database; receiving a target document and a query, wherein the query is related to the target document; processing the target document to create target document embeddings; storing the target document embeddings to the vector database; processing the query to create query embeddings; storing the query embeddings to the vector database; identifying at least one relevant reference document by comparing the query embeddings and/or the target document embeddings to the reference document embeddings; using the target document embeddings, the reference document embeddings, and the query embeddings to generate an answer, wherein the answer evaluates the query using the target document and the reference document embeddings; transmitting the answer to a user device; and displaying the answer via user interface on the user device.

In some embodiments, the target document or any of the reference documents can feature one or any combination of a text-based file, a video-based file, an image-based file, and an audio-based file. The method can also include the steps of: storing the target document embeddings to a vector database; storing the reference document embeddings to the vector database; and storing the query embeddings to the vector database.

A generated answer can also include at least one location and location indicator that points to the at least one location in the relevant reference document. In some embodiments, the step of comparing the query embeddings and the reference document embeddings involves calculating cosine similarities between the query embeddings and the reference document embeddings.

One should appreciate that the disclosed subject matter provides many advantageous technical effects including the ability to analyze one document in view of the content of other documents and based on a user's query. This also facilitates the ability to analyze batches of documents in view of reference documents given a specific query and a specific set of reference documents.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a flowchart describing the process of uploading and processing reference documents.

FIG. 2 is a flowchart describing a similar process that is carried out for target documents.

FIG. 3 is a flowchart describing how one or more reference document are used to answer a query about a target document.

FIG. 4 is a flowchart describing how different content is handled in a generated answer.

FIG. 5 is a flowchart describing how answers can be rejected.

FIG. 6 is a flowchart that describes how answer formatting can be carried out.

FIG. 7 shows overall system architecture of embodiments of the inventive subject matter.

FIG. 8 is a visual representation of a flow.

### DETAILED DESCRIPTION

The following discussion provides example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

As used in the description in this application and throughout the claims that follow, the meaning of “a,” “an,” and “the” includes plural reference unless the context clearly dictates otherwise. Also, as used in the description in this application, the meaning of “in” includes “in” and “on” unless the context clearly dictates otherwise.

Also, as used in this application, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, the language expressing numbers, number ranges, quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements. Moreover, and unless the context dictates the contrary, all ranges set forth in this application should be interpreted as being inclusive of their endpoints and open-ended ranges should be interpreted to include only commercially practical values. Similarly, all lists of values should be considered as inclusive of intermediate values unless the context indicates the contrary.

It should be noted that any language directed to a computer should be read to include any suitable combination of computing devices, including servers, interfaces, systems, databases, agents, peers, Engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network. The following description includes information that may be useful in understanding the present invention. It is not an admission that any of the information provided in this application is prior art or relevant to the presently claimed invention, or that any publication specifically or implicitly referenced is prior art.

Retrieval-Augmented Generation (RAG) is an advanced artificial intelligence (AI) technique that combines information retrieval with text generation. It allows AI models to retrieve relevant information from a knowledge source and incorporate it into generated text. This technique optimizes the output of a large language model by referencing an authoritative knowledge base outside of its training data sources before generating a response. The process involves four key stages: indexing, retrieval, augmentation, and generation.

Systems and methods of the inventive subject matter are directed to retrieval-augmented generation (RAG) techniques. RAG techniques described in this application are capable of leveraging AI to retrieve information from various reference documents and then to answer user questions using those reference documents, especially in instances where a user asks questions about a target document. For example, if a user uploads company reimbursement policy documents, that user could then ask whether a specific receipt is compliant with the company's policies on reimbursing expenses. Questions and answers can be used in interpreting and answering follow up questions posed by the user.

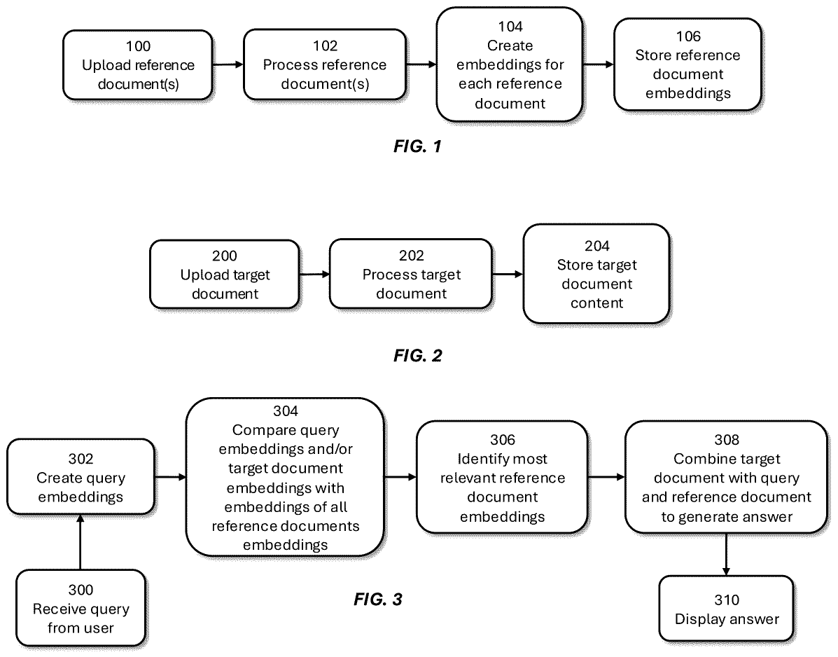

FIG. 1 is a flowchart describing the process of uploading and processing reference documents. Reference documents are uploaded to a platform server of the inventive subject matter from a user's computing device. A reference document in the context of this application is a document that can be referred to in the course of generating answers about a target document. User queries can result in generated answers via automated flows or questions from users that are posed ad hoc. In some embodiments, a user's questions can be used to create flows. For example, if a user asks whether a target document complies with rules stated in a reference document, that query and associated reference documents can be included in a flow that allows the same question to be posed for many different target documents. Flows are discussed in more detail, below. Target documents of the inventive subject matter can include—irrespective of format—text-based files, audio-based files, video-based files, image-based files, or any combination thereof.

In step 100, a user uploads one or more reference documents using a computing device. To upload a document, a user can select a document or set of documents to upload to a platform server, and then trigger an upload via, e.g., user interface. A reference document is a document that contains information, guidelines, rules, and the like. Reference documents are used to analyze target documents, where a target document is a document that can only be understood, analyzed, interpreted, or the like in view of one or more reference documents. Reference documents of the inventive subject matter can include—irrespective of format—text-based files, audio-based files, video-based files, image-based files, or any combination thereof.

In step 102, the platform extracts or otherwise identifies text, tables, and other content from the uploaded reference document (or documents). Following this, in step 104, reference document embeddings are created. Reference document embeddings can be created based on the extracted content from step 102, and they can also be created based on inherent aspects of a document itself, such as color, size, how content is arranged and so on.

An embedding is a numerical representation of a piece of information, such as text, documents, images, or audio. The representation captures the semantic meaning of what is being embedded, making it robust for many industry applications. For example, a document embedder turns a piece of text (several words, sentences, or even multiple paragraphs) into a fixed-sized vector. This vector can be used as input in downstream applications, such as classification models and to conduct vector-based searches.

Vector-based search is a method in artificial intelligence and data retrieval that uses mathematical vectors to represent and efficiently search through complex, unstructured data. Unlike traditional search algorithms that use keywords, vector search represents data points as vectors in a highly-dimensional space and compares the similarity of the query vector to the possible vector paths (in this case, to the vectors created in the process of creating document embeddings in step 104). This enables more sophisticated and accurate searches through large and complex datasets.

Once embeddings are created, those vectors are then stored to a vector database per step 106, ensuring that all relevant embeddings are available for comparison to search vectors. A vector database is a specialized type of database designed to store and manage vector embeddings, which are mathematical representations of data in a high-dimensional space. These embeddings are generated by AI models and are used to represent various types of data, such as text, images, audio, and more. Each dimension in the vector corresponds to a feature of the data, and the position of the vector in this space represents its characteristics. All associated reference documents and target documents can also be stored such that they are accessible to the platform server. By saving reference documents and associated embeddings of those documents, other steps and processes described in this application that require access to reference documents and associated embeddings can access them quickly and easily. The steps in FIG. 1 can be repeated to add more reference documents.

Vector databases are particularly useful for tasks that involve similarity search, semantic search, multimodal search, recommendation engines, large language models (LLMs), and object detection. They are optimized for fast retrieval and similarity search, allowing for efficient data processing and real-time analysis. This makes them useful for applications involving large language models, generative AI, and semantic search, where traditional scalar-based databases may struggle to handle the complexity and scale of vector data.

In the context of AI and machine learning, vector databases enable the storage and querying of vector embeddings, which are useful for understanding patterns, relationships, and underlying structures in the data. They offer capabilities like CRUD (Create Read Update Delete) operations, metadata filtering, horizontal scaling, and serverless architecture, making them efficient and scalable.

Thus, when a query is input into a system, the system creates an embedding of the question and compares it with all the reference document embeddings to find the most relevant reference document. The final step involves combining the document, question, and response to display the answer along with its location, ensuring transparency for both the question and the answer.

The steps described in FIG. 1, above, are directed to document processing, generally. These steps are carried out to prepare uploaded documents for searching via, e.g., vector searching and also to prepare those documents to analyze document relevance. FIG. 2 is a flowchart describing a similar process that is carried out for target documents. In step 200, a target document is uploaded to the platform server. In step 202, the target document is subject to processing to extract information from the document, including text, tables, images and so on. Next, target document content extracted in step 202 is stored according to step 204.

Target document content can be stored in a database. In some embodiments, target document content is stored to the same database that reference document embeddings are stored to, while in other embodiments, content from a target document is stored to a separate database (e.g., a database that is not a vector database, which is more useful in the context of embeddings than in the context of more ordinary data storage).

The steps described in FIG. 3 are directed to using one or more reference documents to answer questions about a target document. First, a query must be input by a user per step 300. That query will relate to a target document, and although the steps described in FIG. 2 can be carried out separately, it should be understood that a target document can be provided with a user's query about that target document. Thus, the steps in FIG. 2 can occur contemporaneously with the steps in FIG. 3. A user's query can comprise words, numbers, questions, and so on, either as natural language question or as a more typical keyword search. Queries typically relate to the target document and ask a question about the target document that can be answered by one or more of the reference documents. A query can also be about just a target document or it can be about just a reference document.

Once a query is received from a user, in step 302, the platform server creates embeddings using the query. Query embeddings can be stored to a vector database (e.g., a single vector database can be used for storage of all embeddings described in this application). In step 304, the platform server compares the query embeddings and/or target document embeddings to reference document embeddings so that in step 306 the platform server can identify, based on comparisons carried out in step 304, the most relevant reference document embeddings. Thus, in step 304 user query embeddings and/or target document embeddings can be compared to reference document embeddings. This step facilitates the following step 304 that involves identifying most relevant reference documents.

A variety of different techniques can be used to identify the most relevant reference documents. One common method is cosine similarity, which measures the cosine of an angle between two vectors. This metric is used to determine how similar two documents are based on their embeddings. A cosine similarity is a measure of similarity between two non-zero vectors of an inner product space that measures the cosine of the angle between them. In the context of documents, it is often used to measure the similarity between text documents represented as vectors (or “embeddings”) in a multi-dimensional space.

When dealing with several documents, each document can be represented by one or more embeddings (e.g., as vectors of term frequencies or TF-IDF (Term Frequency-Inverse Document Frequency) values). By calculating cosine similarities between these vectors, a platform server can determine how similar those documents are to each other. This can be useful for tasks such as document clustering, duplicate detection, and information retrieval.

In some embodiments, relevant reference document identification can involve finding a set of reference documents that match the user's query. Once an initial set of relevant reference documents is identified, document re-ranking can be performed to reorder them based on more contextual and semantic information. Techniques like graph attention networks can enhance this process by considering relationships between entities in a user's query and candidate reference documents. An empirical evaluation of embeddings and similarity metrics, such as cosine similarity, has shown that these methods can effectively gauge the document relevance. This enables efficient analysis of textual data and comparison of document content to, e.g., a user query and/or a target document. Thus, by encoding documents into embeddings and using similarity measures like cosine similarity, the platform server can identify documents that are most relevant to a given query and/or a given target document(s).

Next, the platform server in step 308 uses the target document and/or its embeddings, one or more of the reference documents and/or their embeddings, and the query and/or its embeddings to generate a response (or answer) to the query. In other words, after the platform server identifies the most relevant reference document(s), step 308 describes that the platform server combines the user's query with content from the target document and with a generated answer that points to locations (e.g., one or more) in the most relevant reference document(s) to create an answer. Content in the target document can include text content, tables, individual letters, images (e.g., stored according to some image format), and so on.

To generate an answer from a user's query, the user's query can be packaged into a query package together with one or more reference documents (e.g., one or more reference documents and/or embeddings of the one or more reference documents), one or more target documents (e.g., one or more target documents and/or embeddings of the one or more target documents), and a system prompt, and the query package can then be sent to an LLM for processing. A system prompt can be, e.g., a set of instruction for an LLM that dictate how the LLM should interpret and answer the query in a query package. For example, a system prompt can include, “answer yes or no for Boolean questions, don't give additional text” to cause the LLM to return only “yes” or “no” responses from the LLM when presented with Boolean questions. Once assembled, a query package is thus transmitted to an LLM (e.g., OpenAI's ChatGPT).

In one illustrative example, a target document is a person's resume, and the user submits a query asking, “does this person meet the criteria for a job as an attorney?” The reference documents that are uploaded are entitled, “Attorney Job Description,” “JD for Marketing,” “Expense Report Policy,” and “Engineering Change Management Policy.” Next, the platform server creates embeddings of the user's query, the target document, and the reference documents, and uses those embeddings to identify one or more relevant reference documents. The platform server can use an LLM create document embeddings, to identify the most relevant reference document(s), or both. In this case, the most relevant reference document is “Attorney Job Description.” The platform server thus generates a query package that can be sent to an LLM, and in this example the LLM could develop the response, “Hmm, it looks like the most relevant document for this question is the document entitled ‘Attorney Job Description,’ which requires a law degree, but the applicant has an engineering degree.”

In some situations, the platform server only needs to use a target document to generate an answer (e.g., a user asks whether the target document is a receipt), in some other situations, the platform server uses one or more of the reference documents to answer a question about the reference documents themselves, while in still other situations, the platform server answers a question about a target document in view of one or more reference documents.

The response the platform server can thus apply information from one or more of the reference documents to the target document to generate an answer to the user's query. For example, if a user uploads a receipt along with company policy documents and then asks if the receipt complies with the company's reimbursement policy, the platform server could apply the target document to the company policy documents to answer the user's question.

In step 310, the platform server transmits the answer to a user (e.g., to a user's device) so the user's device can display the answer. This terminology can be shortened to, e.g., “the platform server displays the answer,” which should be understood as either directly or indirectly causing a user's computing device to display the answer (or to display any sort of content). Displaying content on a user's device can involve displaying that content via user interface. As mentioned above, an answer can indicate what part of a document (e.g., a target document or a reference document) the platform server used to develop the answer. This can be accomplished by, e.g., citation to a relevant portion (or portions) of the document.

Answers of the inventive subject matter are generally generated in response to an API call (e.g., an API call to an LLM where the call comprises a query package). Such an API call would request an answer to be generated, and the answer would then be formed using information that can be sorted into three classes of information: Model (e.g., document type), Fields (e.g., key-value pairs), and Features (e.g., additional data such as signatures, OCR, etc.). Answers that are delivered to a user (e.g., to a user's device) can include those classes of information as well as a synthesis of that information (e.g., an LLM generated response that uses the information retrieved by the API call).

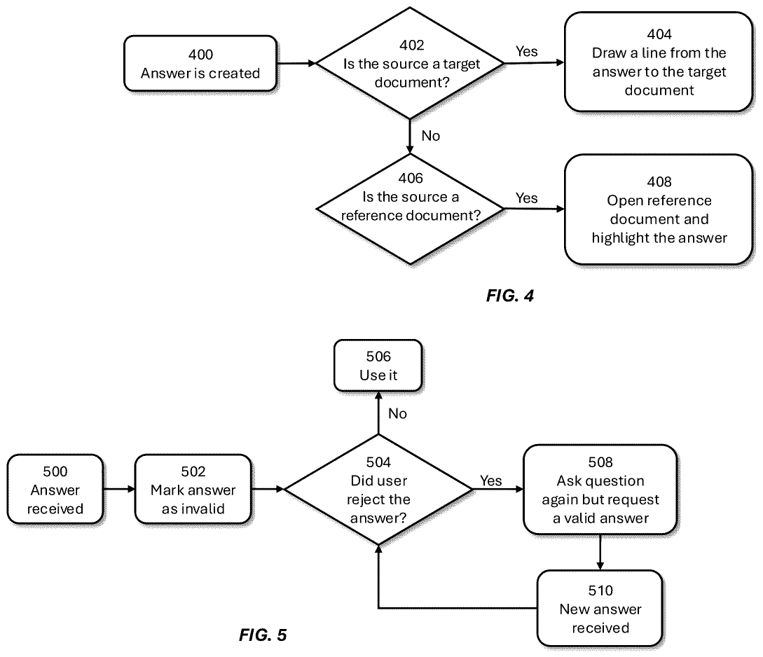

FIG. 4 is a flowchart describing how different content is handled in a generated answer. According to step 400, an answer is created. This step encapsulates everything discussed above, and it should be considered a continuation from the steps described in FIG. 3. Next, the platform server determines in step 402 whether the source for the answer is a target document. If “yes,” then in step 406, the platform server can draw a line from the answer to the target document. If “no,” then in step 406 the platform server determines whether the source is a reference document, and if “yes,” then the platform server can open the reference document and highlight the portion of the reference document used to generate the answer. FIG. 4 thus describes how an answer the platform server generates can be related back to a document that the answer relies on. In some cases, multiple sources can be relied on for an answer. To handle multiple sources, the steps describes in FIG. 4 can be followed for each source until all sources have been considered.

FIG. 5 is a flowchart describing how answers can be rejected. In step 500, an answer is received by a user, and in step 502, the user marks the answer as invalid. Answers are generated according to steps described above in FIG. 3. Once marked as invalid, thereby rejecting that answer, the platform server checks whether the user has rejected the answer in step 504. In practical terms, step 504 can occur the instant a user either rejects or accepts and answer, though for purposes of explanation and in the context of the flow chart in FIG. 5, step 504 is treated as a separate inquiry. An answer might be rejected as invalid if, for example, the answer does not make sense contextually, it does not adequately answer the question posed, the answer does not include a proper citation to a reference document, and so on.

If a user has not rejected an answer, then the answer can be used according to step 506. In other words, no follow up inquiries are required and a user can rely on that answer without any additional steps taken. On the other hand, if a user rejects an answer, the platform server moves to step 508 where the user asks the question again with a request for a valid answer. In step 510, the new answer is received and the user is given another opportunity to reject the answer per step 504. This process can loop until a non-rejected answer is generated.

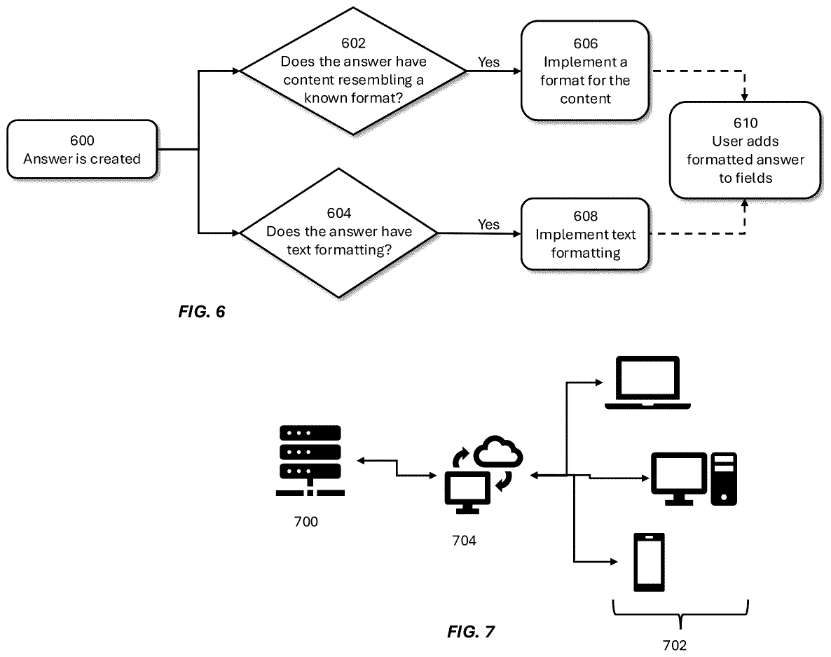

FIG. 6 is a flowchart that describes how answer formatting can be carried out so that answers generated according to embodiments of the inventive subject matter are presented in visually organized or otherwise aesthetically coherent ways. In step 600, an answer is generated by the platform server. All or portions of answers of the inventive subject matter can be formatted as text. In some embodiments, a text-based answer can be formed as a phrase, clause, sentence, a set of words, or the like. In some embodiments, a text-based answer can include formatted information such as markdown, HTML, CSS, JS, a JSON, or the like. Answers can include one or any combination of any type of answer discussed above. Answers generated by systems of the inventive subject matter can be interpreted by, for example, an artificial intelligence model to check whether the answer features any text and whether the text features any kind of rich formatting (e.g., markdown or the like). If rich formatted, the text of the answer displays according to the rich formatting (e.g., as a table, an HTML image on the website, and so forth).

According to step 602, the platform server then determines whether the answer includes any content that resembles a known format. If any content in an answer resembles a known format, then in step 606 the platform server implements a format for that content such that when the answer is displayed to a user, the answer features as much visually useful formatting as possible. For example, some content may resemble a table, and thus according to step 606, that content would be displayed in a table. The same can be true for images, HTML, IMG tags, and so on. For videos, a video player can be displayed according to step 606.

In step 604, the platform server determines whether the answer includes any content resembling text. If any text content is present, then in step 608 text formatting is applied to the text content. In step 610, a user can add new entries an answer's fields. This step is optional as indicated by the dotted lines from steps 606 and 608 that point to step 610. Because answers generate by API call feature classes of information including Model, Fields, and Features, step 610 describes a step in which a user can add a new entry in a Field of the answer. Thus, a user can add a new key-value pair to an answer (e.g., to a Field portion of an answer), which can modify or improve the answer. The key in such a case can be a question, and the value can be an answer to that question.

Embodiments of the inventive subject matter work to address issues of trust and reliability in automated document analysis in a variety of ways, including by introducing improved transparency. For example, an answer to a question posed by user may be considered not trustworthy without easily verifiable proof such as a citation to a location in a reference document that was relied on in generating an answer. Embodiments of the inventive subject matter address this by always providing answers with citations to references. But beyond merely citing to a reference at large, embodiments cite to specific locations within those references that were relied on to generate an answer. By including a specific location for information from a cited reference, a user receiving an answer can transparently see where the answer came from and how the reference document was applied.

How a platform server of the inventive subject matter handles target documents contributes to transparency. For example, target documents are not interpreted by the platform server as entire documents but instead are broken down into chunks, e.g., OCR text chunks, tables, fields, and so on. For any structured data in a target document (e.g., tables, fields, etc.), those are prioritized over OCR text chunks. In other words, the more structured the input is, the more structured an answer can be. Generally speaking, it can be advantageous to show an answer's source to a user so the user can verify the answer. If the source of an answer is indicated as being an entire document, then a user would need to read the entire document to verify that answer. This process would be unreasonably time-consuming. Thus, answers of the inventive subject matter can indicate one or more specific locations within a document as a source for an answer.

To make this possible, documents can thus be broken down into chunks. These chunks can be, e.g., a few sentences, a row of a table, a key-value pair, and so on. In some instances, overlapping chunks can be created, where, for example, the same text in OCR, in a table, and in a field are all interpreted in separate chunks. That way, when a user requests an answer, an LLM can be prompted with, e.g., “provide an answer and indicate a chunk that was most relevant to developing the answer.” The identified chunk used to generate the answer can be used to create, e.g., an X-Y-width-height-page number chunk location indicator, which can then be used to highlight the relevant chunk in a document.

Thus, if an answer resulted from a table in a target document, then when the answer is presented to a user, the answer can indicate where in the target document it came from as precisely as pointing to the content of individual cell in a table. If an answer is sourced from a text chunk, then the platform server can indicate the chunk of text from which the answer was sourced (e.g., typically 3-4 lines of text), and in some cases specific words of phrases can be indicated. As a fallback in cases where a more specific location of an answer cannot be identified, the platform server can indicate a page from which the answer was developed. By indicating where in one or more reference documents answers are sourced, embodiments are transparent and feature easily verifiable answers. Locations can be indicated on one or more reference documents visually (e.g., by applying bounding boxes around the relevant content, by overlaying arrows, by applying highlighting, and so on), by citation (e.g., written citation indicating a location), or the like. In some embodiments, an answer includes a portion of a reference document with a relevant location included instead of providing an entire reference document with locations highlighted throughout.

While embodiments are primarily designed for text-based target documents, documents containing visual data can also be handled via, e.g., multimedia search (by using a visual LLM). The ability to handle visual content can be applied in a variety of contexts. For example, in the insurance industry, a system of the inventive subject matter could handle questions like: “is a vehicle accident covered by a policy?”; “is a leak a result of human error?”; “was emergency services called on site?”; “how many vehicles were involved in an accident?”; “what time of day did an accident occur?”; and so forth. By uploading, e.g., a picture of an auto accident, many of these questions can be answered by interpreting visual information in the photograph and applying it to relevant reference documents (e.g., insurance policy documents).

Thus, embodiments can be configured such that user queries can be about a wide variety of target documents or content featured in target documents, including: unstructured text (e.g., documents, arbitrary text), structured text (e.g., forms, tables, databases, document tables), images (e.g., JPG, PNG, TIFF, HEIC, or any other image format), audio and video transcripts, and websites and webpages.

Reference documents can exist in what are referred to as “flows.” A flow in the context of the inventive subject matter refers to a sequence of steps or processes that can be carried out in view of some fixed set of reference documents. Because a flow involves a fixed set of reference documents, the platform server can create embeddings for those reference documents before the flow is used to answer questions about a target document. Pre-embedding can involve extracting text, tables, and other content from the documents, creating embeddings based on this content, and storing these embeddings in a vector database. Once accomplished, a flow that involves pre-embedded reference documents can skip the embedding step for reference documents, saving time and making a flow more efficient for subsequent uses. Thus, a flow ensures that all relevant embeddings are available for comparison when a query is input to a platform server. This process functions analogously to web search indexing, where websites are indexed by a search engine to improve search times when user's actually conduct searches.

When multiple reference documents are uploaded to a platform server, e.g., for use in a flow, embodiments can give different weights to different reference documents. For example, if multiple reference documents are uploaded and one is newer than all the others, the newest reference document can be weighted more heavily than older reference documents. In some embodiments, weighting can ensure that only the most up-to-date reference document (or documents) are used to generate an answer when an answer indicates, e.g., multiple reference documents that are different versions of the same document, thus ignoring older, out-of-date reference documents.

Embodiments of the inventive subject matter can also feature a multimodal fallback. User queries can be written in a way that requests a certain type of content. For example, if a user asks, “does this receipt comply with company policy?” the user expects an answer to be returned as text, and platform server accordingly expects to search through reference document text for content supporting an answer. In another example, a user may ask, “are there emergency services on site” in relation to an image. In such a case, a text-only LLM would not be able to answer that question (because a text-only LLM cannot interpret visual information). That user query can thus only be answered by visual inspection, which gives rise to a need for some systems to incorporate a multimodal LLM.

But in some embodiments, the best reference document may exist as an image instead of as a text-based document. In that case, the platform server would switch to interpret the query as a request for data from an image rather than a request for data in a text-based document.

For example, a user can submit a query asking for text data (e.g., OCR and tables), but if the answer is not satisfactory or an LLM underpinning the process recommends an image search, the platform server can handle the query as if the query was directed to an image. In this way, embodiments can handle queries and generate answers using any type of reference document, regardless of the type of query a user presents.

Thus, large language models (LLM) can be used in embodiments of the inventive subject matter in a variety of different ways. For example, an LLM can be implemented to interpret queries, generate embeddings, generate plain language answers, interpret the content of target and reference documents, and all the other ways described in this application. For queries, a user can input a query, which can be in the form of words, numbers, questions, and so on, either as natural language or as a more typical keyword search, and an LLM can then be used to process that query and to facilitate in the process of creating embeddings from that query.

Embodiments of the inventive subject matter are described throughout this application with some basic assumptions regarding hardware architecture. FIG. 7 shows overall system architecture of embodiments of the inventive subject matter. Because embodiments are typically configured as a software as a service, there is a platform server side 700 (e.g., software running on cloud servers) and there is a user device side 702. Between the platform server side 700 and the user device side 702 there can be a network layer. At all times throughout this application, when a user is described as acting, it should be understood as describing a user taking an action on a user device that can communicate with a platform server via network connection to either transmit or receive information according to software on the user device (e.g., an application, a web browser, etc.). And when the platform server is described as acting, it should be understood as describing a cloud server taking an action according to computer software installed on the platform server and giving rise to the described action or actions.

When answers are generated according to systems and methods described in this application, those answers are delivered to user devices 702 from platform server 704. User devices 702 thus display those answers on a display screen. Answers can be displayed on a user interface that displays all information incorporated into an answer of the inventive subject matter including, e.g., relevant reference documents with highlighted locations.

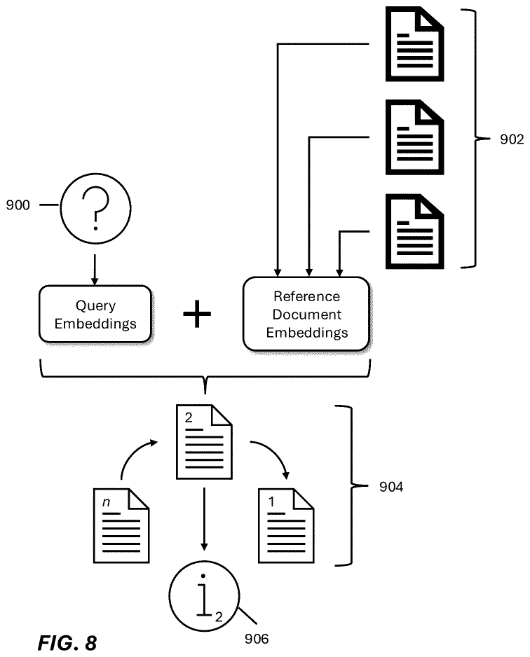

FIG. 8 is a visual representation of a flow. This flow comprises a query 800 and reference documents 802. The platform server creates query embeddings and reference document embeddings using the query and the reference documents. With all embeddings created and the flow created, the flow can be applied to multiple target documents 804 (by using target document embeddings). Target documents are labeled 1, 2, and n to indicate that n number of target documents can be run through a flow, where n can an integer value greater than 0. The number of target documents is limited only by computation times, which is why the steps taken to improve efficiencies described in this application are so important. For each target document that is run through the flow, an answer 806 is generated.

Thus, specific methods directed to the use of vector search and generative AI to answer questions about target documents in view of reference documents have been disclosed. It should be apparent, however, to those skilled in the art that many more modifications besides those already described are possible without departing from the inventive concepts in this application. The inventive subject matter, therefore, is not to be restricted except in the spirit of the disclosure. Moreover, in interpreting the disclosure all terms should be interpreted in the broadest possible manner consistent with the context. In particular the terms “comprises” and “comprising” should be interpreted as referring to the elements, components, or steps in a non-exclusive manner, indicating that the referenced elements, components, or steps can be present, or utilized, or combined with other elements, components, or steps that are not expressly referenced.

What is claimed is:

1. A method of using artificial intelligence to generate responses to queries about target documents in view of reference documents, the method comprising the steps of:
receiving a set of reference documents;
processing the set of reference documents to create reference document embeddings for each reference document in the set;
receiving a target document and a query, wherein the query is related to the target document;
processing the target document to create target document embeddings;
processing the query to create query embeddings;
identifying at least one relevant reference document by comparing the query embeddings to the reference document embeddings;
using the target document embeddings, embeddings of the at least one relevant reference document, and the query embeddings to generate an answer, wherein the answer evaluates the query using the target document and the at least one relevant reference document;
transmitting the answer to a user device; and
displaying the answer via user interface on the user device.

2. The method of claim 1, wherein the target document comprises at least one of a text-based file, a video-based file, an image-based file, and an audio-based file.

3. The method of claim 1, wherein each reference document comprises at least one of a text-based file, a video-based file, an image-based file, and an audio-based file.

4. The method of claim 1, further comprising the steps of:
storing the target document embeddings to a vector database;
storing the reference document embeddings to the vector database; and
storing the query embeddings to the vector database.

5. The method of claim 1, wherein the answer further comprises at least one location that features a visual indicator applied to the at least one relevant reference document.

6. The method of claim 1, wherein the step of comparing the query embeddings and the reference document embeddings involves calculating cosine similarities between the query embeddings and the reference document embeddings.

7. A method of using artificial intelligence to generate responses to queries about target documents in view of reference documents, the method comprising the steps of:
receiving a reference document;
processing the reference documents to create reference document embeddings;
storing the reference document embeddings to a vector database;
receiving a target document and a query, wherein the query is related to the target document;
processing the target document to create target document embeddings;
storing the target document embeddings to the vector database;
processing the query to create query embeddings;
storing the query embeddings to the vector database;
identifying at least one relevant reference document by comparing the query embeddings and/or the target document embeddings to the reference document embeddings;
using the target document embeddings, the reference document embeddings, and the query embeddings to generate an answer, wherein the answer evaluates the query using the target document and the reference document embeddings;
transmitting the answer to a user device; and
displaying the answer via user interface on the user device.

8. The method of claim 1, wherein the target document comprises at least one of a text-based file, a video-based file, an image-based file, and an audio-based file.

9. The method of claim 1, wherein the reference document comprises at least one of a text-based file, a video-based file, an image-based file, and an audio-based file.

10. The method of claim 1, further comprising the steps of:
storing the target document embeddings to a vector database;
storing the reference document embeddings to the vector database; and
storing the query embeddings to the vector database.

11. The method of claim 1, wherein the answer further comprises at least one location that features a visual indicator applied to the at least one relevant reference document.

12. The method of claim 1, wherein the step of comparing the query embeddings and the reference document embeddings involves calculating cosine similarities between the query embeddings and the reference document embeddings.
